(19) United States
(12) Patent Application Publication
(10) Pub. No.: US 2013/0258720 A1
(43) Pub. Date: Oct. 3, 2013

(54) RESONANT POWER SUPPLY WITH AN INTEGRATED INDUCTOR

(71) Applicants: Cezary Worek, Krakow (PL); Slawomir Ligenza, Wolbrom (PL)

(72) Inventors: Cezary Worek, Krakow (PL); Slawomir Ligenza, Wolbrom (PL)

(73) Assignee: AKADEMIA GORNICZO-HUTNICZA IM STANISLAWA STASZICA W KRAKOWIE, KRAKOW (PL)

(21) Appl. No.: 13/990,432

(22) PCT Filed: Dec. 1, 2011
(86) PCT No.: PCT/EP11/71499

§ 371 Date: May 30, 2013

(30) Foreign Application Priority Data
Dec. 3, 2010 (PL) 393133

(51) Int. Cl. H02M 3/335

(52) U.S. Cl. CPC H02M 3/33507
USPC 363/21.02

(57) ABSTRACT

A resonant-mode power supply comprising an integrated inductor (ZER), the integrated inductor (ZER) comprising an inductor (IR) and a transformer (TR). The main internal winding (1) of the transformer (TR) is surrounded by magnetic elements (2, 3) for closing the magnetic flux lines around the main internal winding (1) of the transformer (TR), wherein at least one magnetic element (2, 3) is surrounded by at least one auxiliary external winding (4) of the inductor (IR) arranged orthogonally to the main internal winding (1) of the transformer (TR), and the power supply being configured such that during operation the current (I₁) flowing through the inductor (IR) is shifted in phase with respect to the current (I₂) flowing through the primary winding of the transformer (TR).

### TECHNICAL FIELD

The present invention relates to a method for increasing power transferred by an integrated inductor and an integrated inductor suitable for a resonant-mode power supply with a quality-factor limiter.

### BACKGROUND ART

Two main types of resonant voltage converters are known from the prior art literature: series converters and parallel converters. They are provided with bridge or half-bridge commutation structures supplying energy to resonant circuits. The control of the resonant circuit frequency allows controlling the resonant circuit voltage and current, and therefore the power supplied to the load. The main advantages of resonant converters are the possibility of commutating large currents at zero voltage thus minimizing commutation losses and, consequently, allowing generation of quasi-sinusoidal currents, which in turn reduces the level of generated interference. In order to ensure favourable conditions for semiconductor devices commutation in converter and inverter circuits, there are used complex resonant structures comprising a plurality of reactance elements. The most widely used are series-parallel structures provided with additional elements. Under resonance conditions, particularly if the current supplied to load has to be as close to sinusoidal as possible, the peak current values in the resonant circuit are considerably exceeding the maximum load current. Therefore, the resonant circuit reactance elements should enable energy transfer in the amount significantly exceeding the amount of energy being drawn. Larger amounts of energy accumulated in inductive elements require their larger dimensions and weight. It is, therefore, purposeful to seek solutions that allow reduction of the converter magnetic components mass thus reducing the converter manufacturing cost and its total mass.

This goal can be achieved by integration of inductive elements in such a manner that certain portions of the magnetic circuit are simultaneously utilized by at least two inductive elements.

The U.S. Pat. No. 5,886,516 presents an integrated multi-winding magnetic element intended for operation in a series resonant converter, in which on a single “UU” gapped magnetic core are located two windings of an isolation transformer and two additional windings constituting two inductive elements of the resonant circuit. This assembly constitutes a resonant circuit consisting of three inductances, two capacitances and an isolation transformer.

An integrated-magnetic apparatus is known from the U.S. Pat. No. 5,726,615, comprising three ferromagnetic pot cores, two of which have central core-columns carrying two flat windings located around these columns. These two inductive elements constitute a transformer. The third ferromagnetic pot core has a shorter central core-column around which a flat winding is placed. The third core-piece located adjacent to flat exterior surface of the transformer allows to form the third inductive element. The third inductive element is partially magnetically coupled through an air gap to the other windings and is phased to have the magnetic induction in the same direction as the magnetic induction in the ungapped magnetic circuit.

The U.S. Pat. No. 7,525,406 presents a structure that contains a plurality of coupled and non-coupled inductive elements and at least one closed magnetic circuit comprised of mutually contiguous magnetic elements having groves for current conductors in the X-axis and the perpendicular to it Y-axis. The current conductors located along the same axis exhibit mutual inductance but none between mutually orthogonal axes.

Mutual transfer of orthogonal magnetic fluxes by means of the central ferromagnetic core-piece is known from the U.S. Pat. No. 7,525,406.

The above examples illustrate embodiments of integrated reactance elements suitable for operation in typical resonant DC/DC converters. However, the aforementioned integrated reactances elements do not fully utilize the specific operating conditions of combined reactance elements, which allow also improving of some operating parameters.

### DISCLOSURE OF THE INVENTION

The object of the invention is a resonant-mode power supply comprising an integrated inductor, the integrated inductor comprising an inductor and a transformer, wherein the main internal winding of the transformer is surrounded by magnetic elements for closing the magnetic flux lines around the main internal winding of the transformer, wherein at least one magnetic element is surrounded by at least one auxiliary external winding of the inductor arranged orthogonally to the main internal winding of the transformer, and the power supply being configured such that during operation the current flowing through the inductor is shifted in phase with respect to the current flowing through the primary winding of the transformer.

Preferably, the magnetic elements of the integrated inductor are separated by non-magnetic gaps in at least one of a vertical and a horizontal plane.

Preferably, the shift in phase between the currents is close to 90°.

Another object of the invention is a method for increasing electric power transferred by an integrated inductor in a resonant-mode power supply comprising an integrated inductor, the integrated inductor comprising an inductor and a transformer, wherein the main internal winding of the transformer is surrounded by magnetic elements for closing the magnetic flux lines around the main internal winding of the transformer, wherein at least one magnetic element is surrounded by at least one auxiliary external winding of the inductor arranged orthogonally to the main internal winding of the transformer, wherein the electric power transferred by the integrated inductor is increased by choosing the values of induction elements of the resonant-mode power supply such that during operation the current flowing through the inductor is shifted in phase with respect to the current flowing through the primary winding of the transformer.

### BRIEF DESCRIPTION OF DRAWINGS

The invention is shown by means of exemplary embodiment on a drawing, in which:

FIG. 1 shows a half-bridge structure of a multi-resonance power supply with the quality factor limiter based on the integrated inductor ZER.

FIG. 2 shows an exemplary embodiment of the integrated inductor in which variable magnetic inductions produced by the transformer and inductor and superimposing in selected areas, are mutually orthogonal.

FIG. 3 shows an exemplary embodiment of the integrated inductor wherein variable magnetic inductions in selected areas have been shown, which originate from the transformer and inductor windings, and which are orthogonal with respect to each other.

FIG. 4 shows orthogonal induction vectors originating from transformer windings By(t) and from inductor windings Bx(t), as well as resulting induction vector Bxy(t) at different moments.

FIG. 5 shows the magnetic field energy in the integrated inductor vs. time.

### MODES FOR CARRYING OUT THE INVENTION

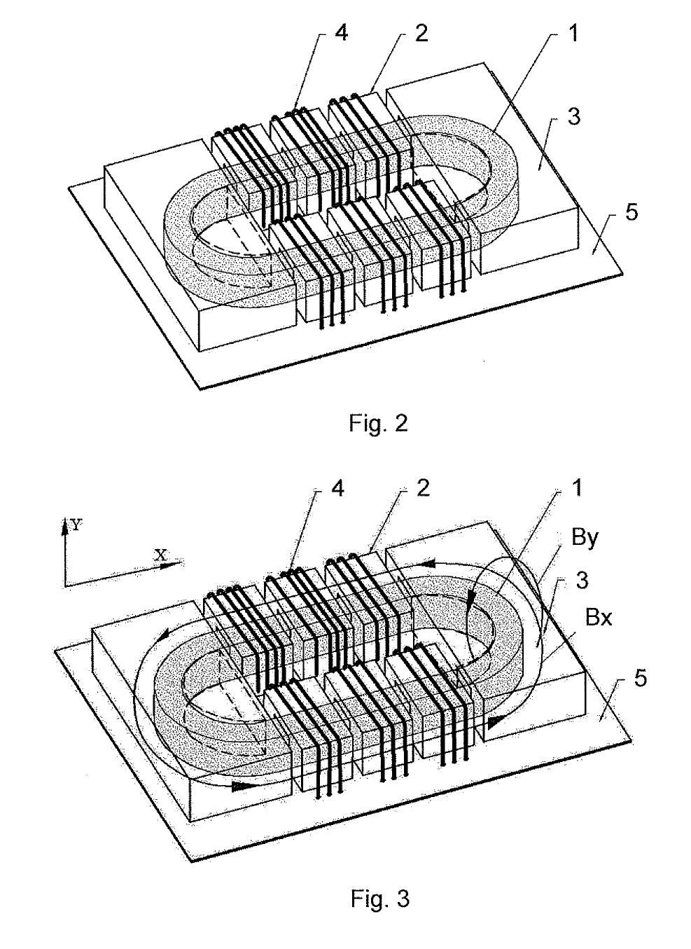

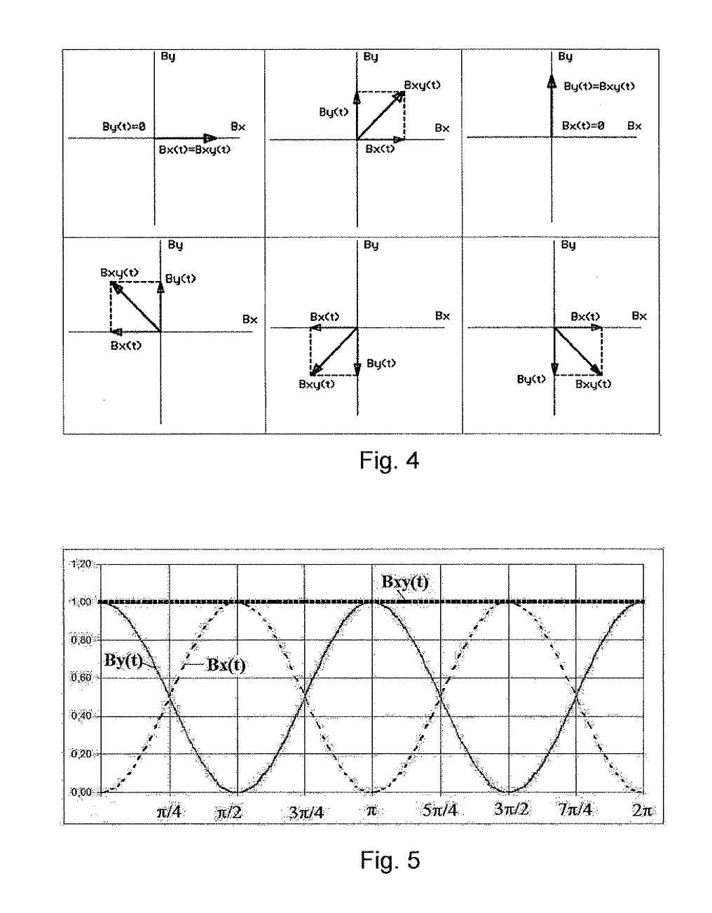

The integrated inductor shown in FIG. 2 comprises a plurality of closed-path magnetic elements 2, which are a combination of “U”-type and “I”-type core-pieces, and two closing magnetic core-pieces 3 of “EP”-type. Said magnetic elements entirely surround the internal windings I of the transformer. Such structure minimizes the leakage flux of the transformer windings. On the other hand, the inductor's magnetic circuit contains a plurality of air gaps and therefore allows achieving a more uniform magnetic field and reducing leakage flux of the inductor comprised of closed-path magnetic cores 2 and the inductor 4 winding. In the example embodiment shown in FIG. 2 the magnetic elements are located on a PCB laminate 5 and utilize the conductive layer on the other side of the board for the inductor 4 windings connections. For the sake of clarity, material filling the gaps between the closed-path magnetic elements 2 is not shown. The gaps may be filled by air or by a non-magnetic material. An advantage of the integrated inductor shown in FIG. 2 is that using an appropriate number of the closed-path magnetic elements 2 it can be easily adapted to different values of transferred power. Mutually orthogonal positioning of the transformer 1 winding and the inductor 4 winding causes the magnetic inductions produced by these windings in the closed-path magnetic elements 2 are oriented orthogonally with respect to each other, as shown in FIG. 3. An additional advantage is the time-shift between both magnetic induction vectors, achieved by the appropriate choice of relative values of reactance elements included in the resonant-mode power supply. It allows increasing the amount of energy stored per unit of the magnetic material volume. For this purpose, the phase shifts between the magnetic inductions superimposing in a selected portion of the magnetic circuit should be chosen to achieve possibly the greatest sum of peak energies stored during a single period in inductances of the integrated inductor. A properly chosen phase shift value allows increasing this sum without exceeding the saturation induction permissible for the magnetic material used. FIG. 4 shows orthogonal induction vectors originating from transformer windings By(t) and from inductor windings Bx(t), as well as resulting induction vector Bxy(t) at different moments: (starting from the top left corner) 0, π/4, π/2, 3π/4, 5π/4 and 7π/4.

FIG. 5 shows the magnetic field energy which is proportional to the square of the magnetic induction, stored in the orthogonal magnetic fields originating from the transformer By(t) and the inductor Bx(t), as well as the resulting sum of these energies, which in this case (when the amplitudes of the induction vectors are equal and orthogonal to each other and shifted in phase by π/2) is constant and time-independent.

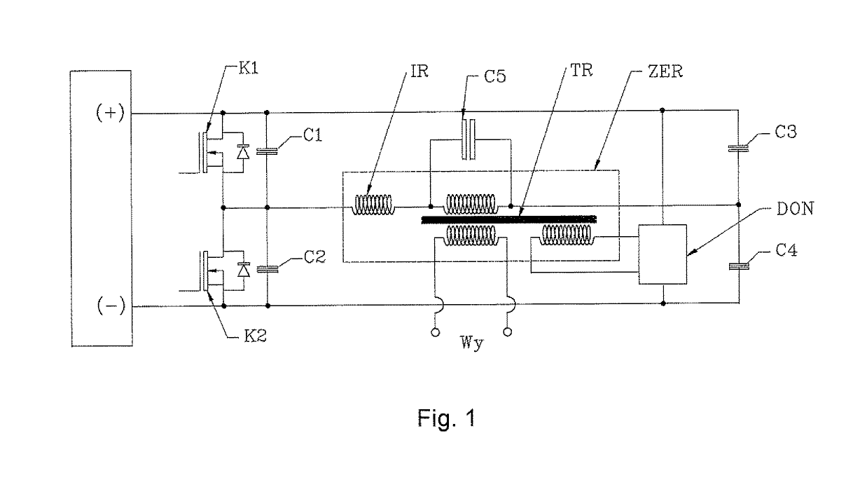

FIG. 1 shows a resonant-mode power supply employing the integrated inductor ZER. The integrated inductor incorporates the inductor IR and transformer TR provided with three windings: the primary winding, connected in series via the inductor IR with transistor switches K1, K2, the output winding and the control winding connected to the diode voltage limiter DON. The primary winding is also connected to the capacitive assembly C3, C4. Since there exists a series connection of the capacitive assembly C3, C4 with the inductor IR, the resultant impedance of elements connected in such a manner is strongly dependent on frequency thus allowing to control the voltage supplied to the primary winding of transformer TR. Since under resonance conditions the transformer TR output voltage can attain large values the present invention employs a limiting circuit comprised of the control winding connected with the diode voltage limiter DON.

The exemplary embodiment of the integrated inductor according to FIG. 1 is depicted in FIG. 2 where the transformer TR is made using the closed-path magnetic elements 2, closing magnetic components 3 and the transformer winding 1 which contains the primary winding, the secondary winding and the control winding. The inductor IR being a part of the integrated inductor ZER employs said closed-path magnetic elements 2, closing magnetic components 3 and the inductor winding 4 which is distributed evenly around the said closed-path magnetic elements 2. in other embodiments, the inductor winding can be also arranged around the closing magnetic components 3. However, preferably the inductor winding surrounds the magnetic components 2 having the smallest cross-section so as to limit the length of the winding wire.

In the resonant-mode power supply according to FIG. 1 it is possible to achieve, between the current I₁ flowing through the inductor IR and the current I₂ flowing through the primary winding of the transformer TR, a constant phase shift close to ±90°. These currents have associated magnetic induction fluxes described by vectors B₁(t) and B₂(t). The following analysis will relate to a point at a section of the magnetic circuit wherein both fluxes overlap. In addition, it is to be assumed that at this point the vectors B₁ and B₂ have equal amplitude.

When the vectors B₁(t) and B₂(t) are parallel, the length of the resulting magnetic induction vector can be defined as:

|B_{R}(t)|=B·(sin ωt+cos ωt)=B·\sqrt{2}·sin(45°+ωt)=B_{AR}·sin(45°+ωt)

The maximum amplitude of the induction vector resulting from both currents will be:

B_{AR}=B·\sqrt{2}

Therefore, in order not to exceed the saturation induction B_{MAX}, the useful value of the induction will be at most:

$$B = \frac{{B}_{MAX}}{\sqrt{2}}$$

When the magnetic induction vectors B₁(t) and B₂(t) in the combined magnetic circuit are oriented orthogonally with respect to each other, the length of the resulting vector can be written as:

|B_{xy}(t)|=\sqrt{B²·sin² ωt+B²·cos² ωt}=B·\sqrt{sin² ωt+cos²ωt}=B=B_{MAX}

The value of energy for a selected portion of the magnetic circuit is proportional to the square of the value (vector length) of the magnetic induction. Therefore, for a case wherein the induction vectors are arranged orthogonally, the sum of the peak energy values for the selected portion of the magnetic circuit can be doubled. In that case, two inductive elements are constructed utilising the same portion of the magnetic circuit, each of them having capability to operate at the maximum magnetic induction value B, close to the saturation induction B_{MAX}. Therefore, by utilising the same portion of the magnetic circuit for two windings, the amount on stored energy is increased. The sum of peak energy values is increased while maintaining the same amplitude of the magnetic induction vector.

Resonant-mode power supplies different than that of FIG. 1 can be used as embodiments of the invention, provided that the power supply is configured (by appropriate selection of inductance values) such that during operation the current (I₁) flowing through the inductor (IR) is shifted in phase with respect to the current (I₂) flowing through the primary winding of the transformer (TR).

The best results, i.e. the best increase in power transferred by the integrated inductor, are achieved when the shift in phase between the currents (I₁, I₂) is close to 90°, but for smaller phase shifts smaller power increases will be achieved as well.

1. A resonant-mode power supply comprising an integrated inductor (ZER), the integrated inductor (ZER) comprising an inductor (IR) and a transformer (TR), characterized in that the main internal winding (1) of the transformer (TR) is surrounded by magnetic elements (2, 3) for closing the magnetic flux lines around the main internal winding (1) of the transformer (TR), wherein at least one magnetic element (2, 3) is surrounded by at least one auxiliary external winding (4) of the inductor (IR) arranged orthogonally to the main internal winding (1) of the transformer (TR), and the power supply being configured such that during operation the current (I₁) flowing through the inductor (IR) is shifted in phase with respect to the current (I₂) flowing through the primary winding of the transformer (TR).

2. The resonant-mode power supply according to claim 1, characterized in that the magnetic elements (2, 3) of the integrated inductor (ZER) are separated by non-magnetic gaps in at least one of a vertical and a horizontal plane.

3. The resonant-mode power supply according to claim 1, characterized in that the shift in phase between the currents (I₁, I₂) is close to 90°.

4. A method for increasing electric power transferred by an integrated inductor in a resonant-mode power supply comprising an integrated inductor (ZER), the integrated inductor (ZER) comprising an inductor (IR) and a transformer (TR), characterized in that the main internal winding (1) of the transformer (TR) is surrounded by magnetic elements (2, 3) for closing the magnetic flux lines around the main internal winding (1) of the transformer (TR), wherein at least one magnetic element (2, 3) is surrounded by at least one auxiliary external winding (4) of the inductor (IR) arranged orthogonally to the main internal winding (1) of the transformer (TR), wherein the electric power transferred by the integrated inductor (ZER) is increased by choosing the values of induction elements of the resonant-mode power supply such that during operation the current (I₁) flowing through the inductor (IR) is shifted in phase with respect to the current (I₂) flowing through the primary winding of the transformer (TR).
